(19) United States
(12) Patent Application Publication
(10) Pub. No.: US 2017/0075799 A1
(43) Pub. Date: Mar. 16, 2017

(54) VISUALIZATION OF TRANSACTION OVERLAPS

(71) Applicant: CA, Inc., Islandia, NY (US)

(72) Inventor: Rich J. Lau, Deer Park, NY (US)

(21) Appl. No.: 14/853,928

(22) Filed: Sep. 14, 2015

(51) Int. Cl. G06F 11/36; G06F 3/0484

(52) U.S. Cl. CPC G06F 11/3688; G06F 3/04842

(57) ABSTRACT

Transaction data is be accessed that was generated during monitoring of a plurality of transactions involving a plurality of software components in a system. From the transaction data, a flow of a first one of the plurality of transactions is determined that describes participation of a first subset of the plurality of software components in the first transaction. A flow of a second one of the plurality of transactions is also be determined from the transaction data, the flow of the second transaction describing participation of a different, second subset of the plurality of software components in the second transaction. An overlap is determined between the first and second transactions, the overlap involving a particular one of the software components included in both the first and second subsets of software components.

### BACKGROUND

The present disclosure relates in general to the field of computer systems analysis, and more specifically, to automatically inspecting computer software system architecture.

Modern distributed software systems can enable transactions that cross system and network boundaries, with backend systems communicating with additional backend systems to generate results or provide a service for a client. As an example, online travel reservation systems often involve a frontend website with which users interact on their browser. To search for and complete a reservation in response to a user's request, the host of the travel reservation site may interact with other backend services, including services and systems provided by third parties, such as airlines, car rental companies, hotel companies, credit card payment systems, and so on. These third party services may, themselves, also communicate with and consume services of still further systems, resulting in a chain of transactions and dependencies in response to a single user's request. Additionally, each system itself may be composed of multiple different sub-systems, or components, that interact with each other (and even other systems) in different ways depending on the transaction.

While the breadth and sophistication of the services provided by distributed systems continues to expand and enrich users' lives, the complexity of these systems, their components, and their interoperation also increases. Indeed, it is not uncommon for multiple different enterprises and their systems to be involved in a single transaction. Even within transaction performed by a single entity's system, the multiple composite components of that system are often developed by and “owned” by distinct development teams, with few if any developers or administrators having an in-depth global knowledge of the system and all of its composite parts. This can pose a challenge to developers and administrators as they seek to modify, update, test, verify, and develop components for such software systems.

### BRIEF SUMMARY

According to one aspect of the present disclosure, transaction data can be accessed that was generated during monitoring of a plurality of transactions involving a plurality of software components in a system. From the transaction data, a flow of a first one of the plurality of transactions can be determined that describes participation of a first subset of the plurality of software components in the first transaction. A flow of a second one of the plurality of transactions can also be determined from the transaction data, the flow of the second transaction describing participation of a different, second subset of the plurality of software components in the second transaction. An overlap can be determined between the first and second transactions, the overlap involving a particular one of the software components included in both the first and second subsets of software components.

### BRIEF DESCRIPTION OF THE DRAWINGS

FIG. 1 is a simplified schematic diagram of an example computing system including an example transaction analysis system in accordance with at least one embodiment;

FIG. 2 is a simplified block diagram of an example computing system including an example transaction analysis system in accordance with at least one embodiment;

FIG. 3 is a simplified block diagram of an example system to perform one or more transactions in accordance with at least one embodiment;

FIGS. 4A-4F are simplified block diagrams illustrating example transaction flow paths involving the example system of FIG. 3 in accordance with at least one embodiment;

FIG. 5 is a simplified block diagram illustrating an example determination of an overlap between two or more transaction flows in accordance with at least one embodiment;

FIGS. 6A-6E are screenshots of example graphical user interfaces provided in connection with a transaction analysis system in accordance with at least one embodiment;

FIGS. 7A-7B are screenshots of example graphical user interfaces provided in connection with a transaction analysis system in accordance with at least one embodiment; and

FIGS. 8A-8B are simplified flowcharts illustrating example techniques in connection with determining overlaps between transaction flows in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Peri, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

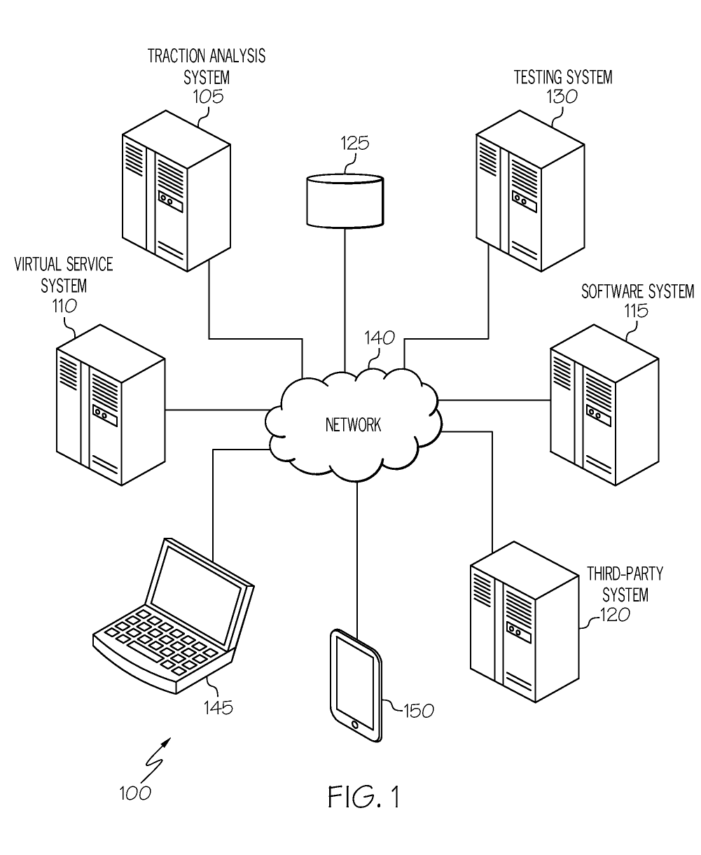

Referring now to FIG. 1, a simplified block diagram is shown illustrating an example computing system 100 including a transaction analysis system 105, virtual service system 110, testing system 130, among other hardware and software computing systems. In some implementations, functionality of the transaction analysis system 105, virtual service system 110, testing system 130, can be combined or even further divided and implemented among multiple different systems. Transaction analysis system 105 can include logic and functionality, implemented in software and/or hardware, for monitoring software transactions involving multiple different software components interacting within the transaction. The transaction analysis system 105 can sort transaction data generated from this monitoring and assess the transaction data to determine transaction fragments for each transaction. Each transaction fragment can include an interaction between two different software components within the transaction. The software components can be components of the same or different application, can be hosted on the same machine, in different machines within a local network, or different remote machines on a wide area network. Each transaction can include multiple transaction fragments. The transaction analysis system 105 can determine, from the transaction data, the ordering of the composite fragments of each transaction as well as the flow of each transaction (e.g., how the transaction proceeds from component to component until completion, as well as the potential alternative paths of the transaction (e.g., according to various decision points within the transaction). A graphical representation of the transaction, its flow, and the components involved in the transaction can be generated. Further, in this particular example, transaction analysis system 105 can also include logic for determining overlaps between transaction flows of multiple different transactions. The overlaps can be used to identify one or more software components and/or one or more transaction fragments included in two or more overlapping transaction flows. The appearance of a common software component and/or transaction fragment within multiple transactions can serve as the basis for determining a level of importance or criticality of the component and/or fragment, among other example uses.

In some instances, transaction data and transaction flow data generated by transaction analysis system 105 can be used in other systems. For instance, some software systems (e.g., 115) can utilize, consume data and services of, provide data or services to, or otherwise be at least partially dependent on or function in association with one or more other computing systems, including third party computing systems (e.g., 120), or data stores, such as database 125, among other examples. Further, virtual models can be generated from captured transaction data that simulate the actions of other systems and software components with which a system under test (e.g., 115) interacts. For instance, a test can be developed for execution by testing system 130 that can make use of virtualized instances (or models) of a third party system (e.g., 120), database (e.g., 125), or other systems and system components, including local system components. These virtualized instances can stand-in for and simulate actions and communication of the corresponding real world components and can interact with the system under test, among other examples

One or more computing systems and services can be hosted on machines communicatively coupled by one or more networks (e.g., 140), including local networks, public networks, wide area networks, broadband cellular networks, the Internet, and the like. Systems with which a system (e.g., 115) under test, development, used in training, etc. can interact can include other data stores (e.g., 125), systems (e.g., 120), and constituent software components accessible over the one or more networks 140. Further, systems and services (e.g., 105, 110, 130, etc.) provided to assess, test, and simulate one or more of systems 115, 120, 125, etc. can also be provided local to or remote from (e.g., over network 140) the target systems, among other examples. Additionally, computing environment 100 can include one or more user devices (e.g., 145, 150) that can allow users to interact with one or more of the servers, services, data structures, and services (e.g., 105, 110, 115, 120, 125, 130, etc.) provided, for instance, remotely over network 140, or at least partially local to the user devices (e.g., 145, 150), among other examples.

In general, “servers,” “clients,” “computing devices,” “network elements,” “hosts,” “system-type system entities,” “user devices,” and “systems” (e.g., 105, 120, 125, 130, 145, 150, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 120, 125, 130, 145, 150, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, a transaction analysis system 105, virtual service system 110, system under test (e.g., 115) or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Software system architectures can be visualized using graphical representations based on monitored transactions involving the system(s). For instance, a graphical representation of a transaction can be generated that illustrates a portion of the system's architecture as well as the flow of the transaction. Similar graphical representations can be generated for any one of several transactions monitored by a transaction analysis system.

Software components within a system may not be single purpose in that they are capable of interfacing with potentially multiple other software components and participating in potentially multiple different transactions and transaction types. Accordingly, the same software component may appear in any one of multiple different transaction flow diagrams generated from corresponding transaction data. In still other implementations, the same transaction fragment (e.g., request-response between two particular software components) may be included in two (or more) different transactions. However, traditional graphical representations of transactions fail to indicate such overlaps between transactions, among other example shortcomings.

When making changes or updates to a software system, such as changes to one or more particular software components, the changes can affect other software components, such as other components which interact with or are dependent on the changed component in one or more transactions. Accordingly, a change to one software component can necessitate changes to other related components. However, the changes to a particular related component may affect the component in unintended ways, such as its operation in other transactions, among other examples. Accordingly, understanding the entire scope of a proposed or actual change to a software component can be difficult, particularly in a complex or distributed software environment.

Determining overlaps between transactions can also be useful in identifying those software components and/or transaction fragments that are involved in multiple transactions and contribute to multiple functions and/or workload of a software application or system. Accordingly, overlaps can serve as the basis for determining a criticality, or importance, of a software component. Criticality can be considered in a variety of contexts, including software development and modifications that affect critical components, testing, security, and other contexts. Visualizing the reasons behind a given software component's criticality can assist users in appreciating how to develop software with such critical software components in mind.

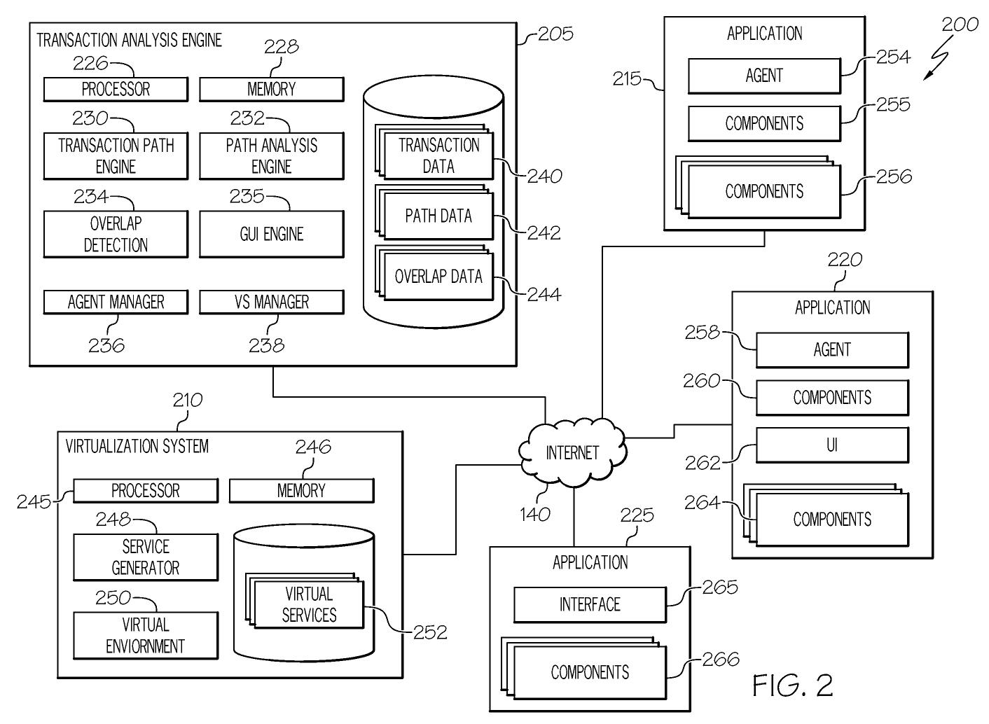

At least some of the systems described in the present disclosure, such as the systems of FIGS. 1 and 2, can include functionality that, in some cases, at least partially remedy or otherwise address at least some of the above-discussed deficiencies and issues, as well as others not explicitly described herein. For instance, tools can be provided that leverage the transaction data and transaction path information generated by a transaction analysis system 105 to identify transaction overlaps within a system and generate graphical user interfaces (GUIs) that represent these overlaps and provide a visualization to developers, admins, system testers, and others of these overlaps. For instance, turning to the example of FIG. 2, a simplified block diagram 200 is shown illustrating an example environment 200 including a transaction analysis engine 205, a virtualization system 210, and one or more services, database management systems, programs, or applications (referred to in this example collectively as “applications”). The systems 205, 210, 215, 220, 225, etc. can interact, for instance, over one or more networks 140. In one example implementation, a transaction analysis engine 205 can include one or more processor devices (e.g., 226) and one or more memory elements (e.g., 228) for use in executing one or more components, tools, or modules, or engines, such as a transaction path engine 230, path analysis engine 232, overlap detection engine 234, graphical user interface (GUI) engine 235, agent manager 236, virtual service manager 238, among other potential tools and components including combinations or further compartmentalization of the foregoing. In some implementations, transaction analysis engine 205 can be implemented as multiple different systems including, for example, varying combinations of the foregoing components and tools (e.g., 230, 232, 234, 235, 236, 238, etc.) and accompanying data (e.g., 240, 242, 244).

In one example, transaction analysis engine 205 can include a transaction path engine 230 configured to inspect a particular application (e.g., 215, 20, 225) or combination of co-functioning applications (e.g., 215 and 220) to identify one or more transactions involving the application(s) as well as the respective software components (e.g., 256, 264, 266) of the applications (e.g., 215, 220, 225) invoked and utilized within the transaction. Information gathered from monitoring or inspection of the transaction can be stored in transaction data 240. Further, the flow path of the transactions can additionally be identified and flow path data 242 can be generated (e.g., using transaction path engine 230) describing the flow between software components (e.g., 256, 264, 266) and the respective contributions, operations, processes, or transaction fragments of the applications within the flow.

In some implementations, transaction path engine 230 can operate cooperatively with an agent manager 236 interfacing with or otherwise managing one or more instrumentation agents (or “agents”) (e.g., 254, 258) deployed on one or more applications (e.g., 215, 220) for use in aiding the monitoring of performance of various components (e.g., 256, 264) of the applications. Agents (e.g., 254, 258) can be software-implemented agents that are configured to provide visibility into the operations of one or more software component (e.g., 256, 264, etc.). Each agent can be configured, for example, to detect requests and responses being sent to and from the component or application in which that agent is embedded. Each agent (e.g., 254, 258) can be further configured to generate information about the detected requests and/or responses and to report that information to other services and tools, such as agent manager 236, virtualization system 210, transaction path engine 230, test execution engine 235, etc. Such information can be embodied as agent data. Additionally, each agent can be configured to detect and report on activity that occurs internal to the components in which the instrumentation agent is embedded or which the agent otherwise is capable monitoring. Agents can be implemented in a variety of ways, including instrumenting each component with a corresponding agent, instrumenting an application or other collection of the software components with a single, shared agent, among other examples.

In response to detecting a request, response, and/or other activity to be monitored, each agent (e.g., 254, 258) can be configured to detect one or more characteristics associated with that activity and/or the monitoring of that activity by the agent. The characteristics can include a frame identifier, which identifies a message, with respect to the agent, sent by the instrumentation agent to a managing service, such as agent manager 236 to report the characteristics observed by the agent. For instance, frames can include a parent identifier, which identifies the requester that generated the request sent to the component or sub-component monitored by the instrumentation agent; a transaction identifier, identifying the transaction, with respect to the component or sub-component being monitored, such as transactions between components carried out through communications and calls made over one or more network connections; and an agent identifier that identifies the agent, with respect to the other instrumentation agents in the testing system, that is generating the characteristics, among other characteristics. Such characteristics can include other information such as a system clock value, current processor and/or memory usage, contents of the request, contents of the response to the request, identity of the requester that generated the request, identity of the responder generating the response to the request, Java virtual machine (JVM) statistics, standard query language (SQL) queries (SQLs), number of database rows returned in a response, logging information (e.g., messages logged in response to a request and/or response), error messages, simple object access protocol (SOAP) requests, values generated by the component that includes the instrumentation agent but that are not returned in the response to the request, web service invocations, method invocations (such as Enterprise Java Beans (EJB) method invocations), entity lifecycle events (such as EJB entity lifecycle events), heap sizing, identification of network connections involved in transactions, identification of messages and data exchanged between components, including the amount of such data, and the like. Characteristics can also include the thread name of a thread processing the request to generate the response and other data describing threads involved in a transaction, the class name of the class of an object invoked to process the request to generate the response, a Web Service signature used to contain the request and/or response, arguments provided as part of the request and/or response, a session identifier, an ordinal (e.g., relating to an order within a transaction), the duration of time spent processing the request and/or generating the response, state information, a local Internet Protocol (IP) address, a local port, a remote IP address, a remote port, and the like, among other examples.

As the above examples indicate, characteristic information can include information generated by the agent itself and information generated and/or processed by the component or sub-component monitored (and collected) by the agent (such as data sent or received by the component that intercepted by one or more agents). The agent can then cause information identifying those characteristics to be provided to one or more other services or tools (e.g., 230, 236 etc.) communicatively coupled to the agent. In some embodiments, each instrumentation agent collects information to form a message, also referred to herein as a frame, which describes characteristics associated with both a detected request and a detected response corresponding to that request. In such embodiments, the respective agent can wait for the response corresponding to the request to be generated and sent before sending the frame to another tool or engine (e.g., 230, 232, 234, 235, 236, 248, etc.) making use of the information in the frame. Additionally, agents can monitor and report characteristics independently for each transaction in which its respective monitored component(s) (e.g., 256, 264, etc.) participates. In addition to monitoring the performance of a component and aggregating information about that component over one or a multitude of transactions (such that information about the performance of individual transactions can, for example, be averaged or statistically assessed based upon the observed performance of the component over the course of multiple monitored transactions), agents (e.g., 254, 258) can additionally provide characteristics that are specific to and correlated with a specific transaction. More particularly, these characteristics that are monitored and reported by the agents can be specific to and correlated with a particular request and/or response generated as a part, or fragment, of a transaction.

In some embodiments, all or some of agents (e.g., 254, 258) can be configured to perform interception and/or inspection (e.g., using the Java™ Virtual Machine Tool Interface, or JVM TI). Such an instrumentation agent can register with the appropriate application programming agent (API) associated with the component or process being monitored in order to be notified when entry and/or exit points occur. This allows the agent to detect requests and responses, as well as the characteristics of those requests and responses. In particular, this functionality can allow an agent to detect when a component begins reading and/or writing from and/or to a socket, to track how much data is accessed (e.g., read or written), obtain a copy of the data so read or written, and generate timing information (as well as information describing any other desired characteristics such as inbound/read or outbound/write identifiers) describing the time or order at which the data was read or written, among other information describing the data accessed, processed, or generated by the component.

In some instances, agents (e.g., 254, 258) can be configured to monitor individual threads by monitoring the storage used by each thread (i.e., the thread local storage for that thread), among other information. Such agents can detect when the monitored thread begins reading or writing to a thread local variable in the thread local storage. In response to detecting this access to the thread local variable, the agent can track the amount (e.g., in bytes, as tracked by incrementing a counter) of data that has been accessed, as well as the starting offset within the thread local storage to which the access takes place. In response to detecting that the thread's access to the thread local variable has ended, the instrumentation agent can use the information about the access to identify characteristics such as the time of the access, the variable being accessed, the value being accessed, network calls being made, and the like.

As noted above, in some implementations, one of the characteristics that can be collected by agents (e.g., 254, 258) can include timing information, such as a timestamp, that indicates when a particular request was received or when a particular response was generated. Such timing information can be included in transaction data 240 and be used, for instance, by transaction path engine 230, to identify that frames, including frames received from different agents, are related to the same transaction. In some implementations, timers used by agents (e.g., 254, 258) can be synchronized to assist in correlating timing information collected between multiple agents. Additionally or alternatively, flow, organization, hierarchy, or timing of a particular transaction can be identified through the generation of transaction identifiers that include characteristics collected by agents (e.g., 254, 258) for use in identifying fragments of the transaction. Such transaction identifiers, or transaction fragment identifiers, can include data collected by instrumentation agents in connection with, for example, the exchange of data, messaging, and other communications between components in the transaction, from thread jumps identified within software processes involved in the transaction, and other features of the transaction or fragments of the transaction.

In some implementations, agents (e.g., 254, 258) can be implemented by inserting a few lines of code into the software component (or the application server associated with that software component) being instrumented. Such code can be inserted into a servlet filter, SOAP filter, a web service handler, an EJB3 method call, a call to a Java Database Connectivity (JDBC) handler, and the like. For example, an agent configured to monitor an EJB can be configured as an EJB3 entity listener (e.g., to monitor entity beans) or interceptor (e.g., to monitor session beans). Some components (or their corresponding application servers) may not provide users with the ability to modify their code, and thus some instrumentation agents can be implemented externally to the component being monitored in a manner that can cause all requests and responses being sent to and/or from that component to be handled by the corresponding agent(s). For example, for an existing database, an agent can be implemented as a driver. Calling components can be configured (e.g., by manipulating a driver manager) to call the instrumentation driver instead of the database's driver. The instrumentation driver can in turn call the database's driver and cause the database's driver to return responses to the instrumentation driver. For example, in one embodiment, the identity of the “real” driver for the database can be embedded in the uniform resource locator (URL) that is passed to the instrumentation driver. In this way, the instrumentation driver can intercept all calls to the database, detect characteristics of those calls, pass the calls to the appropriate database, detect characteristics of the corresponding responses, and then return the characteristics of those calls and responses within corresponding transaction data 240, among other examples.

As requests and responses progress through one or more systems (e.g., 215, 220, 225), additional characteristic information can be captured, for instance, as transaction data 240. For example, a test, simulation, or live operation of one or more software systems (e.g., 215, 220, 225) engaged in one or more transactions can be monitored, for instance, by one or more agents (e.g., 254, 258) and the agents can capture characteristic information associated with requests in the transaction (e.g., the time at which the request was received, the sender of that request, the time at which corresponding requests were sent to a database and/or other service, etc., how much data was exchanged, the identity of the communication channel used in the request or response, and the like) and the corresponding response, and generate transaction data 240 embodying the information. Agents, in some instances, can store at least a portion of the transaction data at the agent and can also, or alternatively, send transaction data 240 to other services and tools. In some instances, transaction data can be generated from or comprise agent data, among other examples.

In one implementation, a transaction path engine 230 can access and utilize transaction information in transaction data 240 to identify fragments of a transaction and organize transaction fragments and accompanying information describing characteristics of the fragment of a particular transaction into groups corresponding to a common transaction. For instance, transaction fragment characteristics can be correlated to group corresponding frames into groups of frames that describe a complete transaction. In some embodiments, in order to group frames, or otherwise identify relationships between frames or transaction fragments, transaction path engine 230 (or another tool) can sort the frames based upon particular characteristics, such as timing information associated with and/or included within those frames. After being sorted, the frames can be arranged in ascending or descending order, with respect to the timing information. For example, the frames can be sorted according to a timestamp indicating when each frame was generated, when one or more requests identified in each frame were generated or received, and/or when one or more responses identified in each frame were generated or received. In some embodiments, the frames can be sorted based upon multiple pieces of timing information. In other examples, frames can be sorted, for example, based on an amount of data exchanged, the identity of a particular communication channel or network connection used, addresses of the receiving and sending components, the identification of the particular agents that provided the frames, etc.

In an additional example, frames and accompanying transaction fragments can be correlated according to the amount and type of data that was received and/or generated, as detected by the agent, as well as information identifying the components or sub-components involved in the monitored activity. For example, such identity information can include information identifying the network ports (e.g., of the requester and responder), IP addresses, network information, or other features describing the communication of a request and corresponding response between a requester and responder. This information can be used to correlate or otherwise identify relationships between two different frames that have similar timing information and data amounts, for example. Identified network connections can be mapped to a particular portion, or fragment, of a transaction, and such fragments can be grouped (e.g., using the collected network connection description data) to identify particular transactions involving multiple different software components (and network connections), among other examples.

Within a group of frames or identified transaction fragments associated with the same transaction, transaction path engine 230 can order, or stitch, the frames to define a chain or order of transaction fragments within a given transaction or set of instances of a similar transaction. The stitching of the frames can be based on determined correlations between grouped frames (e.g., to identify parent-child relationships between given frames and their corresponding transaction fragments). The stitched frames can then define a transaction flow to allow the path, or flow, of the transaction to be followed from the start of the transaction to the end of the transaction and across a chain of potentially many different software components. Each frame can include a field that identifies that frame (e.g., a frame ID), as well as a field that identifies a parent frame (e.g., a parent frame ID). The value of each frame's parent frame ID can equal another frame's frame ID. These frame identifiers can be generated by the agents. In one embodiment, the frame identifiers can be generated from information identifying the IP address (or other addressing information) and port number used by the monitored component or sub-component, the amount of data sent or received by the monitored component during the monitored activity, and/or the instrumentation agent itself, among other information. Relationships can thereby be identified between parent frames, transaction fragments, and software components and corresponding child frames, transaction fragments, and components, to stitch these frames together, among other examples.

In addition to being able to use relationships or correlations to predict or determine a stitching or flowpath of transaction fragments, transaction path engine 230, in some instances can use the lack of correlative data reported by an agent to determine that a given frame corresponds to a transaction fragment that represents a root or leaf (e.g., beginning or end) of a particular transaction or branch of a transaction. For instance, it can be identified that no related connections (or other transaction fragments) involving a particular software component (or just a single correlation) have been identified or reported and conclude, predictively, that the lack of further connections or other reporting data relating to the component or a flow including the component indicate that the transaction terminated at the component, among other examples. Similarly, root nodes can be predictively determined based on the absence of frames documenting an inbound connection at a particular component from which other transaction fragments (and related connections) originate, among other examples.

A transaction path engine 230 can utilize and correlate transaction data 240 (or agent data upon which transaction data is based) generated in part by one or more agents (e.g., 254, 258) to determine one or more transaction flow paths. The transaction path engine 230 can generate and maintain path data 242 describing the determined flow paths involving one or more software components (e.g., 256, 264, 266) or one or more software systems or applications (e.g., 215, 220, 225). Path data 242 can be used in a variety of applications, including testing, verification, and documentation. For instance, test cases to be used to govern and verify results of a test of a piece of software can be developed, in part, from path data corresponding to the piece of software to be tested, among other uses. Further, a path analysis engine 232 can consume path data 242 to perform additional activities and services in support of tests of software systems (e.g., 215, 220, 225), such as identifying boundaries between systems (e.g., 215, 220, 225), components (e.g., 256, 264, 266), and corresponding agents (e.g., 254, 258). Additionally, path analysis engine 232 can identify particular data (e.g., as captured in transaction data or other agent data) that is generated within transactions modeled by the path data 242 and further identify sources of the particular data as well as the path of the particular data as it traverses and is processed by other software components within a transaction before being output as a response or result of the transaction, among other examples. Path analysis engine 232 can further, in some instances, process transaction path data or other data to identify boundaries between system components and systems within a system, as well as boundaries of portions of systems monitored by a respective agent, among other examples.

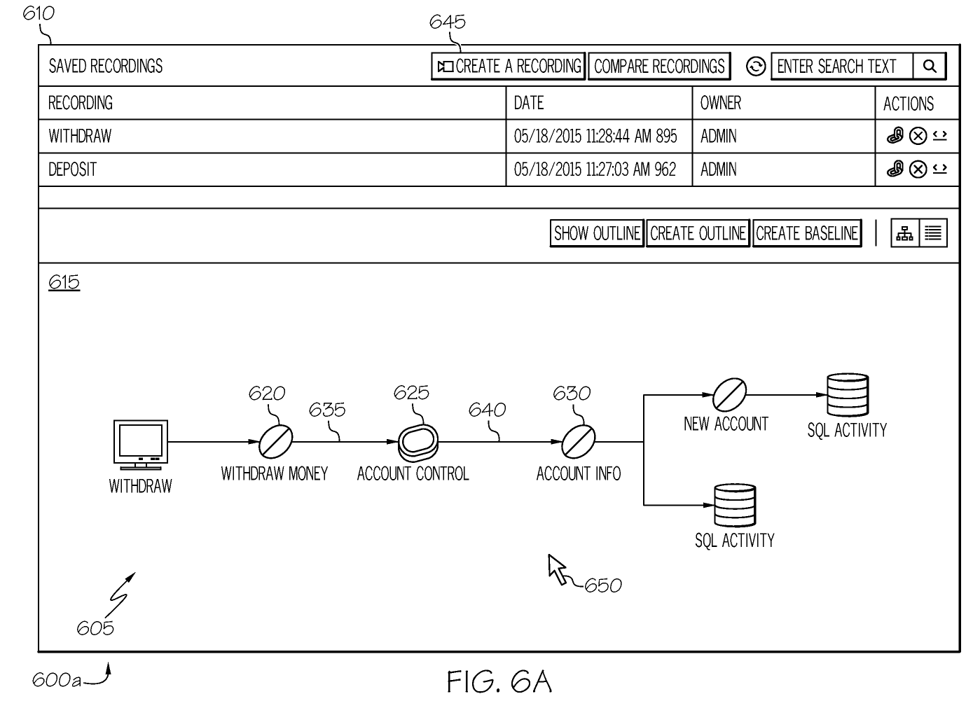

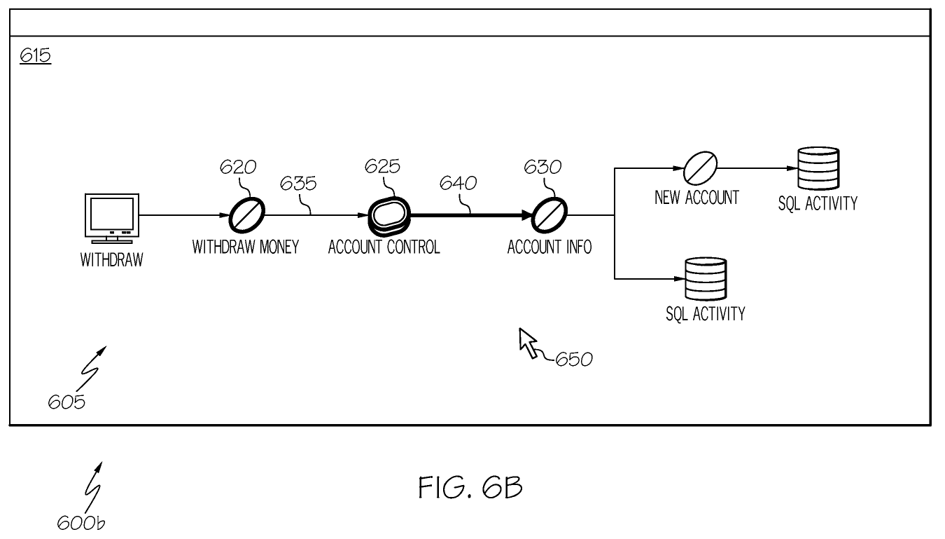

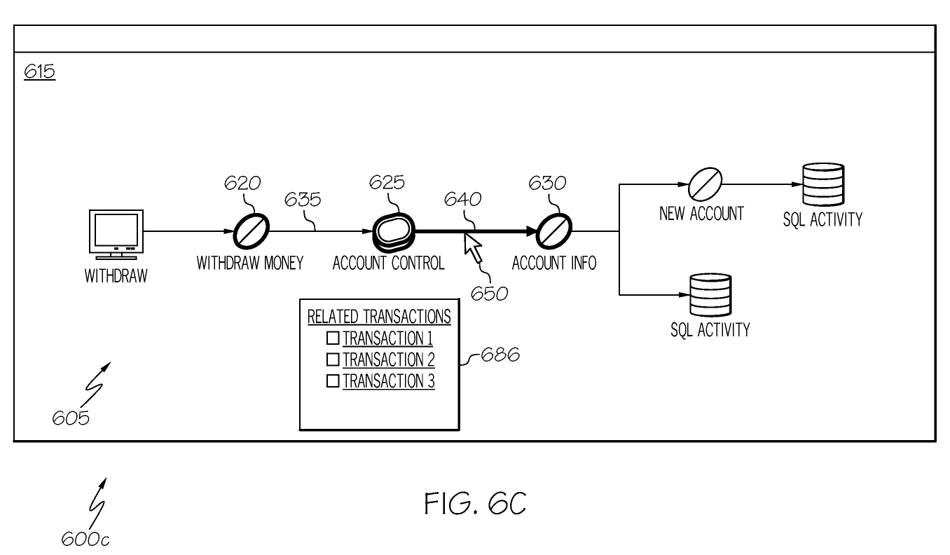

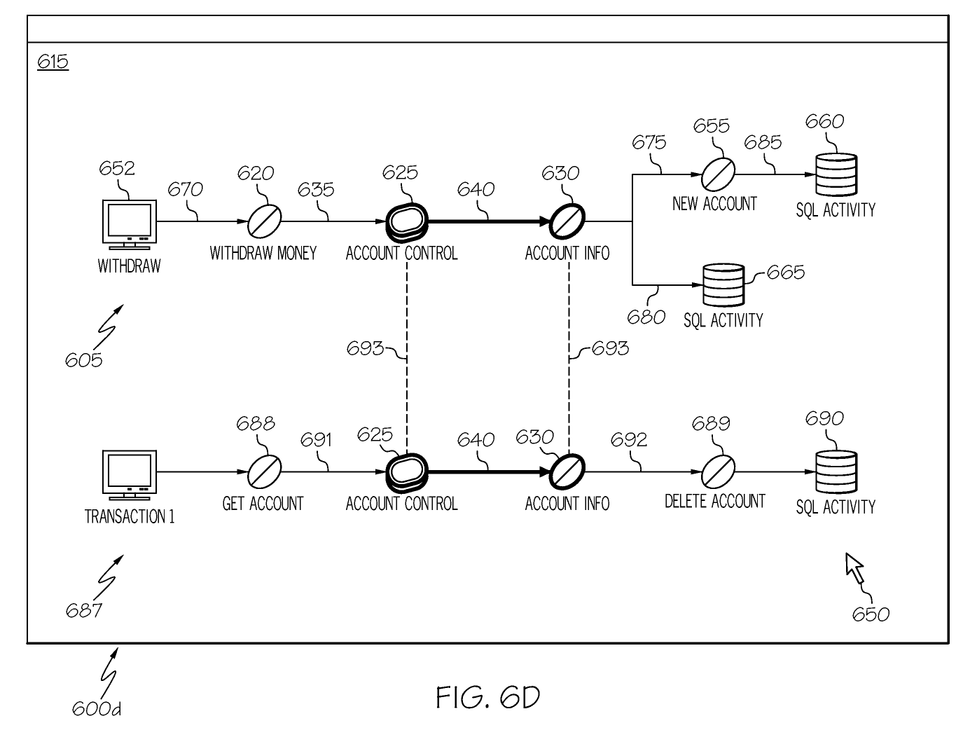

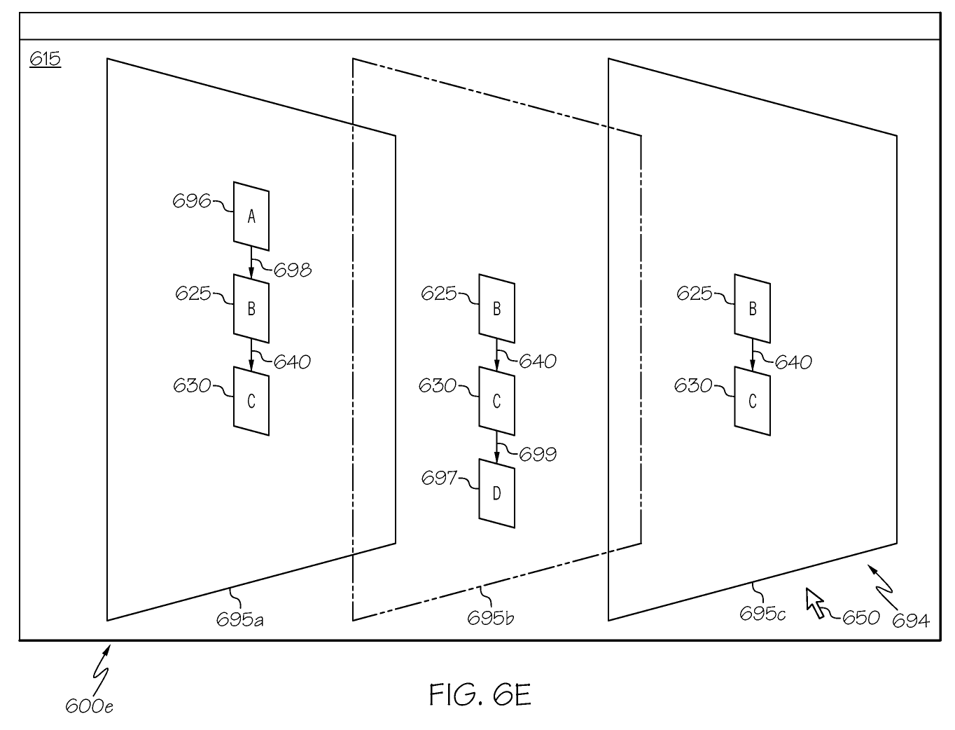

A GUI engine 235 can access path data (and transaction data 240) and render the data to generate graphical representations (in one or more GUIs of the transaction analysis engine) of the transaction information embodied in the path and transaction data. For instance, the GUI engine 235 can be used to generate a graphical representation of the flow of a transaction. The flow can represent a single instance of an observed transaction or the aggregate of multiple observed instances of the same (or multiple different) transactions. For instance, FIG. 6A illustrates one example of a GUI that can be generated using GUI engine. In the example of FIG. 6A, a graphical representation 505 of a transaction “withdraw” is selected (e.g., in GUI window 610) and presented within the GUI window 515. The graphical representation 605 can include graphical blocks (e.g., 620, 625, 630, etc.) representing individual software components identified as participating in the transaction. Further, graphical lines (e.g., 635, 640, etc.) can connect two of the software component representations (e.g., 620, 625, 630, etc.), with each graphical lines (e.g., 635, 640, etc.) representing an observed transaction fragment involving a request and response between the two connected software components. As an example, in FIG. 6A, the graphical representation 605 can include a representation of a transaction fragment (635) that involves a request by a withdrawMoney (Java-based) software component (represented by element 620) sent to a SOAP component accountControl (represented by element 625), which then generates and send a response to the request back to the withdrawMoney element. In this example, and in connection with generating a response to the request by withdrawMoney, the accountControl component (625) can send a request to another component (e.g., AccountInfo (630)) in another transaction fragment (640), and so on (among other examples).

GUI representations of transaction flows generated by GUI engine 235 can be interactive. A variety of information can be collected (e.g., from agents) during monitoring of transactions, including characteristics of each transaction fragment and characteristics of the software components as they are engaged in the transaction. Each of the graphical elements e.g., 620, 625, 630, 635, 640, etc.) included in the representation 605 can be interactive, allowing users to select one or more of the elements to inspect more detailed information concerning the selected software component(s) and/or transaction fragment(s). For instance, selection of a given transaction fragment element (e.g., 635) can cause the GUI to present details concerning the selected transaction fragment including the request(s) and response(s) of the fragment, values and characteristics of the request/response, the response time, the amount of data transmitted in the request and response, the type of data sent in the request and response, the type of transport mechanism used to communicate the request and response, exceptions, logged events, and other data generated in connection with the fragment, among other example characteristics. Further, selection of a given graphical representation of a software component (e.g., 620, 625, 630) can cause the GUI to display information concerning the software component including its name, type, host system, port and socket information, header information, session IDs, local and remote IP address of the component in the transaction, thread information of the component, parent IDs, supported communication protocols, the amount of memory or processing capacity used by the software component in transaction fragments participated in by the software component, exception dumps, among other example characteristics.

Returning to the example of FIG. 2, transaction analysis engine 205 can include an overlap detection engine 234 that can mine transaction data 240 and/or path data 242 to determine one or more overlaps between a set of transactions supported by a software system. In one example, an overlap detection engine 234 can search path data 242 to identify, for each software component, each transaction path in which the software component appears. The transaction paths can include instances of a same transaction or transaction type or transaction paths of different transactions and transaction types. In some cases, overlap data 244 can be generated to identify cases where a software component is detected as involved in multiple different transaction paths. An overlap detection engine 234 can additionally search the transaction path data to identify repeated transaction fragments appearing in two or more of the defined transaction paths. Detection of repeated transaction fragments in the transaction path data 242 can begin with the detection of a repeated instance of a particular software component. For each transaction path in which a particular repeated software component is identified, the path can be searched immediately upstream and downstream from the particular software component to identify whether the particular software component sends requests to or, alternatively, received requests from the same software component in each of two or more of the transaction paths in which the particular software component appears. The path can continue to be searched until the matching transaction path segments diverge. Repeated transaction fragments or chains of fragments (or “segments”) can further be identified in overlap data 244.

A GUI engine 235 can additionally access overlap data 244 and use the data 244 (or other indications of overlaps (e.g., provided directly from the overlap detection engine 234 or path analysis engine 232)) to enhance graphical representations of transaction paths with graphic indications that one or more software components and/or transaction fragments represented in the graphical representation are part of an overlap between transaction paths. Further representations can also be generated using overlap data 244. For instance, graphical representations of multiple overlapping paths can be generated (e.g., by GUI engine 235) that include representations of all or a portion of each of the overlapping paths and how the paths overlap.

In some implementations, a virtualization system 210 can be provided that interoperates with transaction analysis engine 205. A virtualization system 210 can include one or more processor devices 245, memory devices 246, and other hardware and software components including, for instance, a virtual service generator 248, virtual environment 250 for provisioning and executing virtual services, among other examples. A virtualization system 210 can be used to generate and manage virtual services (e.g., 252) that model software components and systems. Such virtual services 252 can be used as stand-ins in tests involving the real-world systems modeled by the virtual service. Determining overlaps in certain flow paths and criticality of certain components can be used in determining which components to virtualize (e.g., virtualizing highly critical components ahead of less critical or used components, etc.). Virtual services 252 can be generated by virtualization system 210 (e.g., using virtual service generator 248) based on detected requests and responses exchanged between two or more software components or systems. Such request and response information can be captured, for instance, by agents (e.g., 254, 258) capable of monitoring a software component that is to be virtualized or that interacts with another software component to be virtualized, among other examples. Virtual services can capture and simulate the behavior, data and performance characteristics of complete composite application environments, making them available for development and testing at the request of a user or system and throughout the software lifecycle, among other advantages.

A virtualization system 210 can include functionality for the creation of complete software-based environments that simulate observed behaviors, stateful transactions and performance scenarios implemented by one or more software components or applications. Such virtual services provide functionality beyond traditional piecemeal responders or stubs, through logic permitting the recognition of input/requests and generation of outputs/responses that are stateful, aware of time, date, and latency characteristics, support such transaction features as sessions, SSL, authentication, and support string-based and dynamic request/response pairs, among other features. Service virtualization and other virtual models can be leveraged, for instance, when live systems are not available due to project scheduling or access concerns. In cases where components have not been built yet, environments can employ virtual services to rapidly model and simulate at least some of the software components to be tested within an environment. Virtual services can be invoked and executed in a virtual environment 250 implemented, for instance, within on-premise computing environments, in private and public cloud-based lab, using virtual machines, traditional operating systems, and other environments, among other examples. In some implementations, virtualization system 210 and virtual services 252 can utilize or adopt principled described, for example, in U.S. patent application Ser. No. 13/341,650 entitled “Service Modeling and Virtualization,” incorporated herein by reference in its entirety as if completely and fully set forth herein.

In implementations utilizing one or more agent managers (e.g., 236), multiple agents (e.g., 254, 258) can communicate with single agent manager 236 via a messaging system. In some cases, agents monitoring components hosted on distinct, or remote, devices can communicate over one or more networks with one or more centralized, or semi-centralized, agent managers 236. In one example implementation, agents (e.g., 254, 258) can communicate with an agent manager 236 using a messaging system such as Java™ Message Service (JMS), among other examples. For instance, agent manager 236 can create a messaging system topic for each transaction (referred to herein as a transaction frame (TF) topic) and subscribe to that TF topic. The instrumentation agents, upon startup, can broadcast their existence to each other and/or to agent manager 236. The agents (e.g., 254, 258) can then get the TF topic from agent manager 236 and begin publishing messages onto a message bus on that TF topic. Agent manager 236 can monitor the published messages and determine whether those messages relate to the current TF topic. As needed, agent manager 236 creates new TF topics for new transactions. In other examples, agents (e.g., 254, 258) can alternatively communicate with agent manager 236 using techniques other than those involving messaging systems. For example, agents can write information to shared data repository (e.g., a database associated with the test system) using database commands, and an agent manager 236 can monitor those database commands to detect new information, among other examples.

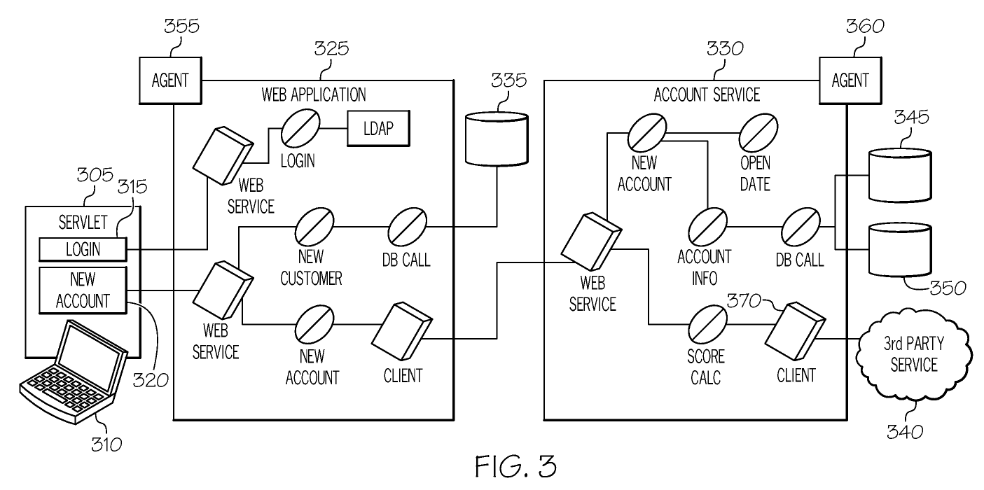

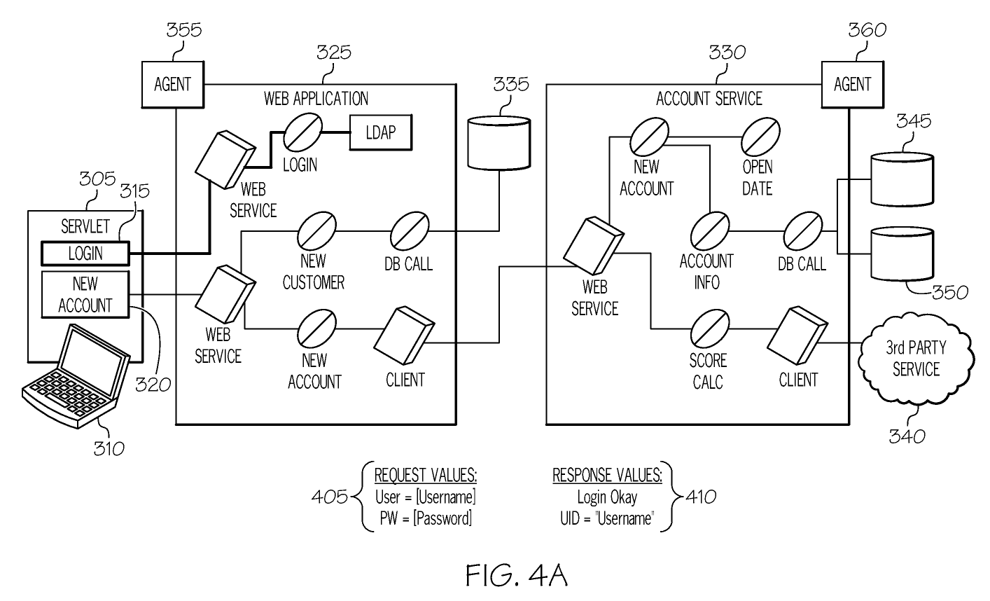

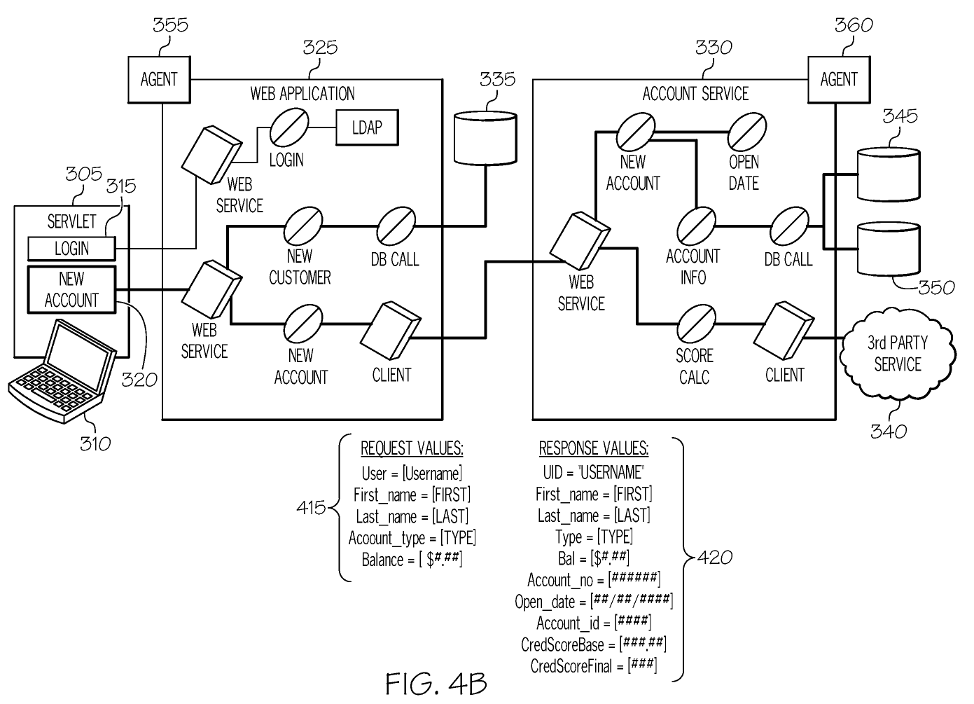

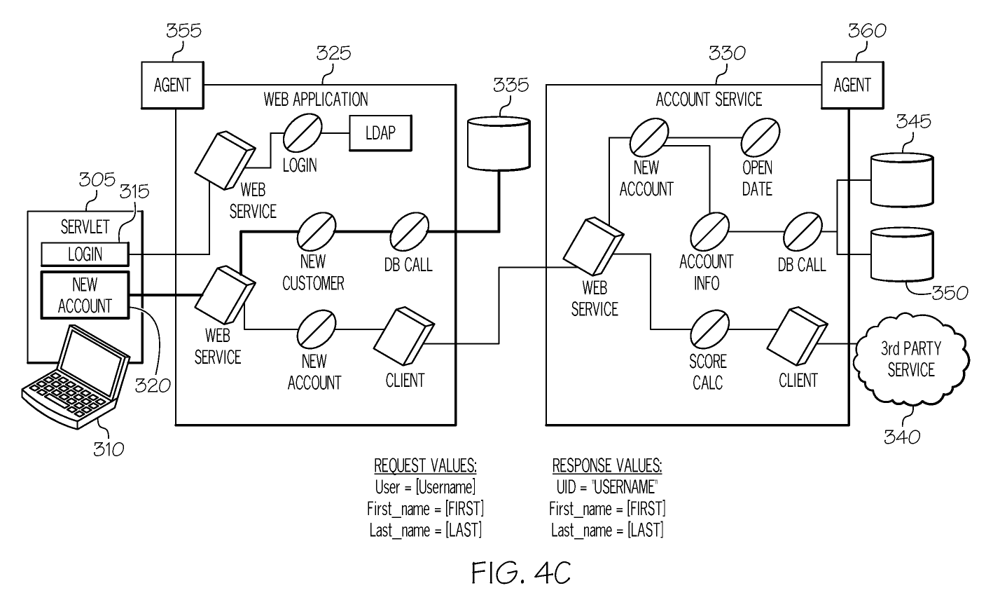

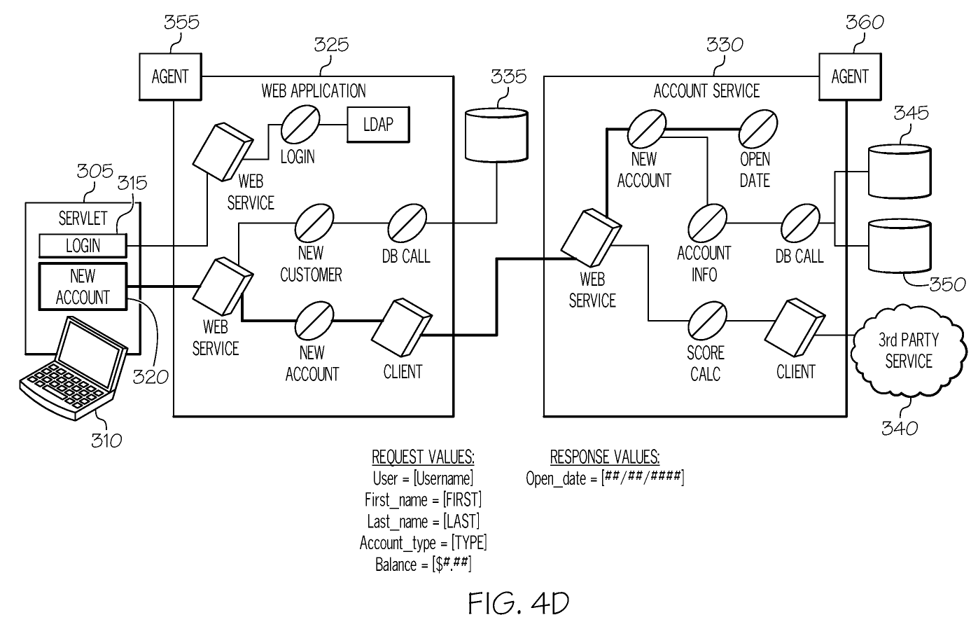

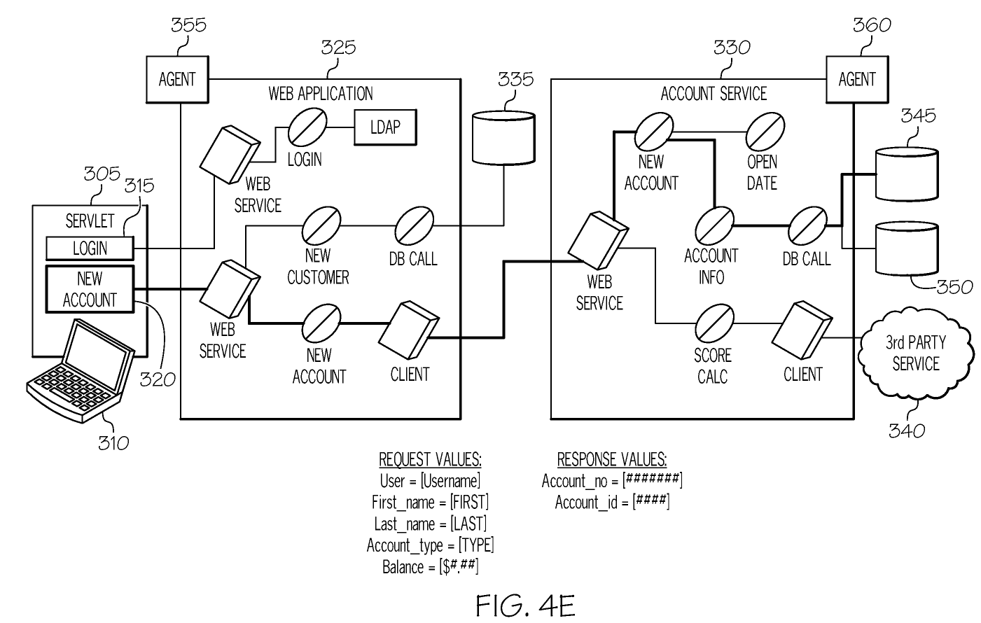

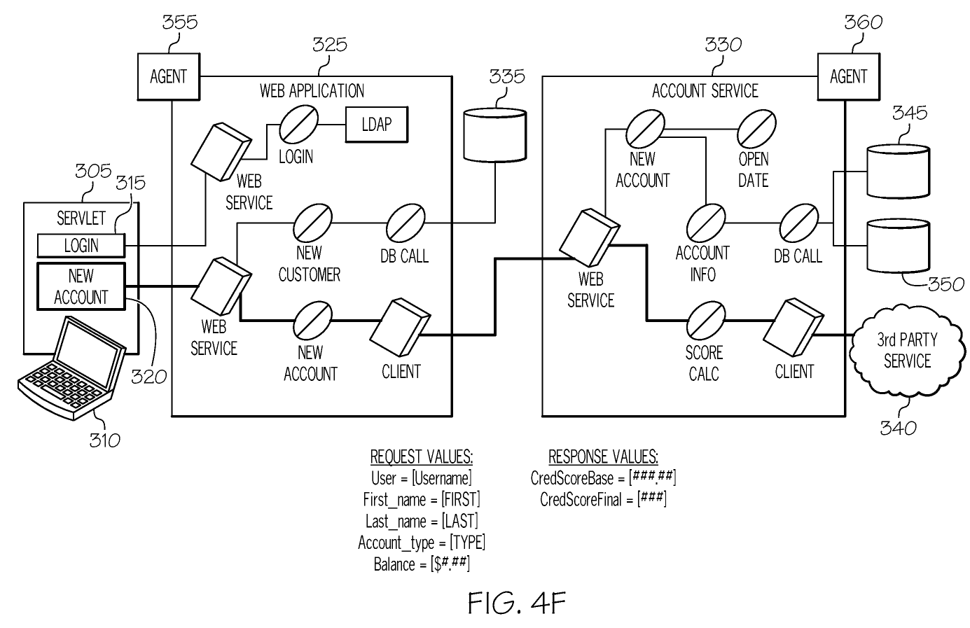

Turning to FIG. 3, a simplified block diagram is shown representing example software systems and components capable of engaging in one or more transactions (e.g., illustrated in FIGS. 4A-4F) that can be monitored and modeled using the example systems and techniques disclosed herein. It should be appreciated that the example systems and transactions shown here are presented for illustrating certain general features and principles and are provided as non-limiting, simplified examples. Indeed, the features and principles discussed herein have application to a potentially limitless array of real-world systems and transactions (e.g., different from those illustrated in FIGS. 3-4F) that can likewise be monitored, analyzed, and tested in accordance with the principled outlined herein.

In the particular example of FIG. 3, a servlet component 305 is provided as a front end for an example Login transaction 315 and New Account transaction 320 accessible to users of user computer devices (e.g., 310). The Login transaction can involve calling a web service of a web application 325 and use of a Login software component (e.g., implemented in this particular example as JavaBean software components) and Lightweight Directory Access Protocol (LDAP) system to facilitate the logging-in of a user into an account of the web application 325. FIG. 4A illustrates the flow path of the example Login transaction 315 as well as example request values 405 of the Login transaction together with example response values 410 returned in the transaction in response to the request values 405. For instance, Login transaction can include a user-provided username and password pair (provided through servlet 305) resulting in a Login Okay response value when the provided username-password pair matches the username-password pair of an existing account managed by the LDAP system of web application 325. Further, the identity of the username can also be returned, for instance, in a welcome message identifying the username.

Returning to FIG. 3, additional transactions can be provided and identified. For instance, the New Account transaction 325 can support the creation and storage of a new account, such as an account for an ecommerce, banking, media subscription, or other application or service. For instance, as shown in the example of FIG. 4B, a more complex flow path can be identified for the New Account transaction 325 including multiple branches in the flow path. For example, upon creation of a new account (using New Account transaction 325) corresponding account information can be entered into a database 335 maintained outside of web application 325 and account service 330. The account information can be generated by one or more software components, such as by software components of account service 330, database 345, third party service 340, or other services and entities. New Account transaction can accept inputs or request values 415, such as username, first name, last name, account type, and account balance (e.g., for a loan, bank, e-payment, or other financial account). These request values 415, when processed in the transaction, can cause the retrieval, generation, and return of response values 420 including response values (such as values corresponding to user ID, first name, last name, account type, and balance) that are at least partially dependent or predictable based on values of the request values 415, as well as additional response values (such as values of an account number, account open date, account ID, credit score, etc.) that are not derived from or based on any of the request values 415.

The flow paths of each respective transaction involving a particular software component or system can be represented in transaction path data generated, for instance, using a transaction path engine. Transaction path data can be generated by grouping and correlating transaction fragment information included in transaction data and/or agent data captured and generated by one or more agents 355, 360 deployed on the software components and/or systems involved in the transactions, as illustrated in the example of FIG. 3. Some software components, such as third party service 340, may be unmanaged in that they are not instrumented with agents under the control of or otherwise accessible to a transaction path engine, test engine, or other tool or entity monitoring the transaction. The involvement and functionality of such unmanaged software components may remain unknown to the tools utilized in the development of transaction paths and tests of a particular transaction, and can be effectively regarded as a black box within the transaction that accepts certain monitored requests and returns corresponding responses captured, in some instances, by the agent (e.g., 360) of a neighboring monitored software component (e.g., SOAP client 370) receiving the response value from the unmonitored component (e.g., third party service 340), among other examples.

In some implementations, a single transaction can include the generation, communication, and use of multiple different response values. The generation and processing of various data within a transaction can involve the transmission of request values and response values to multiple different software components along multiple different sub-paths, or branches, of the transaction flow path. For example, FIG. 4C shows an example of a first branch of a transaction flow path shown bolded in FIG. 4B. The flow path branch of FIG. 4C shows a path for generating and storing a response value in database 335. For example, a response value can be generated or communicated by a New Customer software component for a new customer record utilizing other account information generated in the transaction. Response values such as UID, First_name, and Last_name may be provided from or generated by a New Customer software component or from a database call of database 335, among other examples. The actual values of UID, First_name, and Last_name, in some examples, can be obtained from request values provided by a user, such as the request values User, First_name, and Last_name. In some examples, proper operation of the New Customer software component may be evidenced by the generation of response values UID, First_name, and Last_name that echo request values User, First_name, and Last_name, among other examples.

FIG. 4D illustrates another branch of an example New Account transaction, such as the New Account transaction introduced in the example of FIG. 4B. An account open date (e.g., Open_date) can be one of the response values returned in connection with the New Account transaction. In one example, an Open Date software component can include the logic for generating an account open date to be associated with a record to be provided to database 335 corresponding to the opening of the new account in connection with the New Account transaction. The account Open_date value can be generated by the Open Date component in response to a call from a New Account component of account service 330. The New Account component can additionally manage the generation of additional account data, such as by the Account Info component. The New Account component can be called through a web service call (such as a SOAP call) from web application 325 to account service 330 triggered by a New Account component at web application 325. Accordingly, as shown in the example of FIG. 4D, the invocation of an Open Date software component object can be triggered through a series of calls originating at servlet 305 and the response value Open_date can be generated and passed back from the Open Date component as a response over the same transaction flow path branch to be returned to servlet 305. The value of Open_date can be passed and reappear at each of the components upstream (i.e., in the direction of the flow path toward the software component originating the transaction request (e.g., servlet 305)). The Open Date software component can be identified as the source of the Open_date response value based on an identification of the Open Date component as a leaf in the transaction flow path branch corresponding to the Open_date response value. The Open Date software component can be identified as the leaf of the transaction flow path branch based on, for example, transaction data illustrating that the Open Date software component has no children components but is, instead, only a child component of other components with respect to the Open_date response value and the corresponding transaction path branch, among other examples.

The example of FIG. 4E illustrates another example transaction flow path branch, in this case, relating to the chain of requests resulting in the generation of response values Account_no (e.g., providing the new account number generated for the account) and Account_id (e.g., corresponding to a database record for the new account), generated, for instance, by an unmonitored software component, such as database 345 or other data store, external to monitored software systems 325, 330, among other examples. The values of Account_no and Account_id, as with Open_date, may be independent of the request values provided in the transaction and involve calls by software components across application boundaries and networks connecting two disparate applications (e.g., 325, 330). For instance, the New Account software component of web application 325 may call the New Account software object of account service 330 using a web service call. An Account Info software component of account service 330 may in turn be called to generate values for the new account. For example, a database component 345 may include logic for auto-incrementing account number values (e.g., Account_no) for each new record that is added to the database 345. It can be identified that a database call was made to database 345 and that such a database call is a leaf of the transaction path branch. Further, it can be identified that the database 345 is the source of a particular value, such as in the example of FIG. 4E. Although the database 345 is not monitored by an agent, in some implementations, a transaction path engine or other tool can recognize certain types of calls to external components, such as SQL database calls, inverted list database calls, virtual storage access method (VSAM) calls, indexed sequential access method (ISAM) calls, flat file queries, and cache database calls, among other examples. Through such types of calls, the transaction path engine can make certain assumptions about the nature and operation of the external component. For instance, in the example of FIG. 4E, in instances of a SQL call to component 345, the SQL call can be identified, by an agent 350, and interpreted to conclude that component 345 is a database and the source of the value returned in response to the SQL call, among other examples. For instance, other types of calls can be used to implicitly identify the general character of a software component generating or returning a particular value in a transaction.

FIG. 4F illustrates another example transaction path branch involving a call to an unmonitored third party service 340. Transaction data collected or generated by agents 355, 360 can be processed to create transaction path data that can be analyzed to identify that a CredScoreBase value is returned from a third party service 340 and that the CredScoreBase value is utilized by a Score Calc software component to generate a CredScoreFinal value. Accordingly, an analysis of the corresponding transaction path data can result in the identification of the third party service 340 as the source of the CredScoreBase value and the Score Calc component of the account service 330 as the source of the CredScoreFinal value. As the third party service 340, in this example, is unmanaged, agents 355, 360 used to monitor the transaction are left without intelligence regarding how the CredScoreBase value is generated within the third party service 340, whether other external services are called in connection with the generation of the CredScoreBase value by the third party service 340, and so on. On the other hand, the agent 360 monitoring Score Calc component can identify with precision that the CredScoreFinal value was generated by the Score Calc component based on a CredScoreBase value returned from the unknown third party service 340. Further, agent 360 can capture the value returned by third party service 340 through monitoring of web service client 370, Score Calc component, etc.

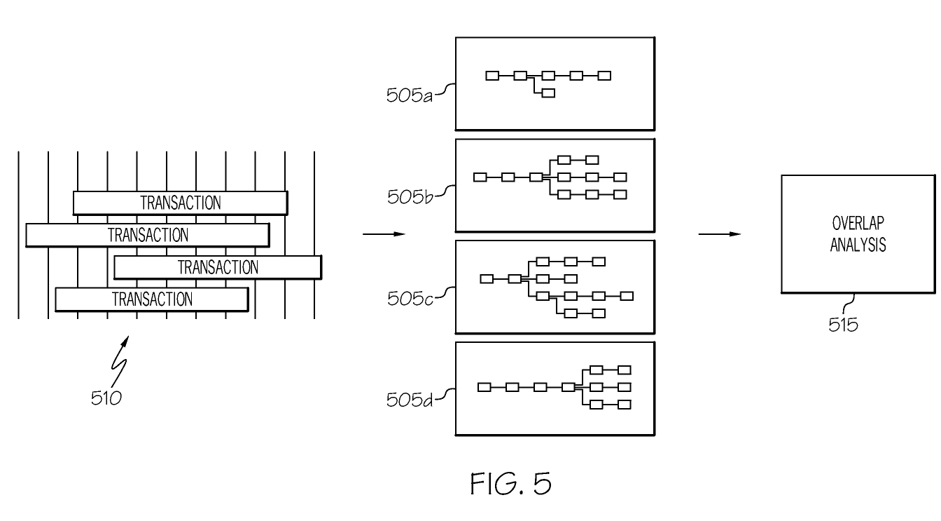

Turning to FIG. 5, a simplified block diagram is shown illustrating the generation of transaction path data (e.g., 505a-d) for each of multiple transactions 510 monitored by one or more agents of a transaction analysis system. As represented in FIG. 5, a system can be engaged in multiple distinct transactions during a single period of time t. The transactions can be transactions occurring within live production operation of the system and/or test transactions (e.g., with a live or test deployment of the system). Further, some of the transactions can be instances of the same transaction type (e.g., different instances of the same login, withdraw, account creation transaction, etc.) or instances of different transaction types that nonetheless use the same software system (and even common software components within the software system). Monitoring of these concurrent transactions can also take place concurrently and transaction data generated from this monitoring can be deposited in memory of the transaction analysis system. The transaction analysis system and/or cooperating agents can then generate path data 505-a-d for each of the monitored transactions 510. Additionally, corresponding graphical representations of each of the flows described in the path data 505-a-d can be made available for rendering in a GUI. In some cases, a single flow diagram can be generated from transaction data from multiple transactions. For instance, transactions that potentially involve multiple different alternative branches can be modeled by observing multiple instances of the transactions such that the flow of each alternative branch is observed. The transaction data from these transactions can be aggregated to define a flow that considers each of the alternative branches and presents a graphical representation showing the flow within each alternative branch.

Upon generating path data 505a-d defining, for each of the transactions 510, the involvement of a respective set of software components of the system and the flow, or ordering, of the software components' involvement (and related transaction fragments), the path data 505-a-d can be analyzed (at 515) by the transaction analysis system to identify overlaps in the respective paths defined in the path data 505-a-d. A representation of these overlaps can then be presented in a GUI illustrating one or more of the transactions according to the corresponding transaction path data for the transactions. The graphical representation of these overlaps can be generated from an on-the-fly determination of the overlaps (e.g., with the transaction analysis system determining the overlaps in real time based on a request to do so from a user) or from overlap data recording previously determined overlaps between transactions. In some cases, when a transaction is recorded and transaction path data generated for the transaction, an overlap analysis 515 can be conducted to catalog any overlaps involving software components and transaction fragments identified within the transaction flow. As these overlaps are associative (i.e., any one overlap involves two or more transaction flows), determining an overlap for a software component can cause that overlap to be added to any other overlaps already determined to involve the software component and/or transaction fragment.

FIGS. 6A-6E screenshots 600a-e of at least a portion of an example GUI 605 that can be presented in connection with the analysis of a transaction path. A graphical representation (e.g., 605) of a transaction path can be generated from a previously monitored, or recorded, transaction (e.g., by selecting from saved recordings in window 610). In other instances, a graphical representation 605 of a transaction path can be generated in response to a newly launched and monitored transaction. For instance, by selecting controls (e.g., 645) provided in the GUI, a new recording can be made. Creating a recording can involve selecting a known transaction capable of being performed by a particular system or by selecting to record all transaction of the particular system (or a selected portion of the particular system) during a period of time. Launching one or more transactions or passively recording operation of the system can result in the generation of new transaction data describing interactions of the software components engaged during the recording, or monitoring, session. Corresponding transaction path (and overlap) data can be generated from the recordings. Further, in response to either the selection of a saved recording (e.g., through interaction with window 610 using a cursor (e.g., 650)) or creation of a new recording (e.g., through control 645), any transaction flows determined from the recordings can be automatically output as graphical flow representations (e.g., 605) presented to the user in the GUI (e.g., in window 615). While the example of FIG. 6A shows a graphical representation 605 of a single transaction, potentially multiple graphical representations can be presented in the window 615 in response to a request. For instance, a request to record general operation of a software system (or traffic on one or more sockets of the software system) can result in the recording of multiple transactions leading to the automatic generation of multiple transaction flow representations within the GUI.

Turning to FIG. 6B, another view of a GUI of a transaction analysis system is shown. In this example, the graphical representation 605 of the example of FIG. 6A is shown, enhanced to identify that one or more overlaps have been determined to exist between the transaction flow path represented by graphical representation 605 and one or more other transaction flow paths (e.g., defined in transaction path data of the transaction analysis system). As an example, software components (e.g., 620, 625, 630) and transaction fragments (e.g., 635) identified as also included in at least one other transaction path can be highlighted to a user. For instance, the lines of the respective graphical elements can be shown in bold, in a different color, or the graphical elements can be otherwise called out through highlighting, arrows, frames, etc. to identify that the corresponding software components (and transaction fragments) correspond to an overlap with at least one other transaction. Other graphical elements of the graphical representation can be shown in a standard, or default, format to indicate that they are not involved in an overlap, such as software component graphical elements 652, 655, 660, 665 and transaction fragment line elements 640, 670, 675, 680, 685.

The presentation shown in the example of FIG. 6B can be shown in response to a user request to make overlaps visible in the graphical representation 605 presented in the example of FIG. 6A. In other instances, overlaps can be graphically represented in the representation 605 by default. The user can interpret the enhanced representation 605 as showing that each of the software components withdrawMoney (620), accountControl (625), AccountInfo (630), and are included in the flow of at least one other transaction path (e.g., that is not currently shown in the window, but for which transaction path data exists). Further, from the enhancements to element 640, the user can interpret that not only do software components accountControl (625) and AccountInfo (630) appear in more than one transaction path, but that the transaction fragment involving these components is also included in more than one transaction path.

As discussed above, the enhanced graphical representation 605 can be interacted with by a user (e.g., using cursor 650) by clicking on one or more of the composite graphical elements (e.g., 620, 625, 630, 635, 640, 652, 655, 660, 665, 670, 675, 680, 685) that make up the representation to navigate to or cause displays of more detailed information concerning the corresponding software component or fragment. Additionally, a user can select one of the highlighted elements (e.g., 620, 625, 630, 640) to explore details of the identified overlap. As an example, turning to the screenshot 600c of FIG. 6C, a user can select graphical element 640 with cursor 650 (or a touch input on a touchscreen or through another interaction with the GUI) and cause a window 686 to be presented showing a listing of other transaction's flow paths in which the transaction fragment appears. This transaction fragment can thereby signify at least a portion of an overlap between these transactions (e.g., “withdraw,” “Transaction1”, “Transaction2”, and “Transaction3”). From this view, a user can select one of the overlapping transactions to cause a representation of the other transaction's flow path to replace or be presented alongside the presentation of graphical representation 605 in some examples. In this example, a user can select one or more of the other overlapping transactions to be presented together with the graphical representation 605 of the flow for transaction withdraw. This can allow a user to visualize the overlap and also understand the delta (or difference) between these overlapping transactions.

As introduced above, graphical representations of multiple overlapping transactions can be presented in a single GUI. Additionally, in some implementations, the presentation of multiple overlapping transaction flows can additionally include graphical elements indicating how the transaction flows overlap. For instance, turning to FIG. 6D, a GUI window 615 is shown illustrating presentation of multiple overlapping transaction paths. For instance, from the window 686, shown in the example of FIG. 6C, a user can select Transaction1 and cause corresponding transaction path representations 687 to be displayed alongside the graphical representation 605 corresponding to transaction withdraw, as shown in FIG. 6D. In the example of FIG. 6D, additional graphical elements (e.g., 693) are displayed highlighting where the two transaction paths (of 605 and 687) overlap. Indeed, the Transaction1 flow is shown, in representation 687, as also including transaction fragment 640, which also involves the accountControl component (represented by element 625) sending a request and receiving a response from the AccountInfo component (represented by element 630). A user can also identify how the overlapping transactions are different. For instance, rather than interacting with a request from withdrawMoney component (620), the accountControl component (625) in the flow diagram 687 of Transaction1 can instead receive a request from a getAccount component (630) in a transaction fragment 691. Likewise, AccountInfo sends a request to a deleteAccount component (692) in a transaction fragment (692) of Transaction1 rather than either a New Account (655) or SQLactivity (665) component, as in the withdraw transaction flow (605).

In another example visualization, shown in FIG. 6E, overlaps between graphical representations of overlapping transactions can be displayed in a three-dimensional (3D) representation 694. For instance, three overlapping transaction flows 695a-c are shown in an example GUI window 615 of a transaction analysis engine. The representation 694 may be presented, for instance, in response to the selection of a user (e.g., through window 686 of FIG. 6C). For instance, the transactions that include the same transaction fragment (640) between the accountControl component (625) and getAccount component (630) can be presented as stacked on top of the other, with the intersecting portions (e.g., graphical elements 625, 630, 640) presented as aligned in the stack. Further, as in other examples, each of the graphical elements (e.g., 625, 630, 640, 696, 697, 698, 699) can be selectable to allow a user to inspect more details regarding the corresponding software component or transaction fragment (e.g., as recorded in transaction data generated from monitoring of the software components and their transactions). While the example of FIG. 6E shows only a portion of each of the full transaction flow representations, in other instances and implementations, the entire flow representation of each overlapping transaction may be displayed (or made possible to be displayed (e.g., by scrolling up and down or side to side in the window)). Further, in cases where transactions have multiple overlapping portions, each of the overlapping portions can be displayed to be aligned within the 3D stack of graphical transaction flow representations, among other examples.

Overlaps between transactions can illustrate critical software components and transaction fragments within a system. A criticality value can be determined for one or more (or all) of the components within the system. Criticality can indicate the importance of the component within the system. Criticality can be measured by a score calculated for each component. Criticality can be based, in part, on the number of different transactions (or transaction fragments) that use the particular software component. Further, not only can the potential use of a software component be considered, but the frequency of the software component's use can also be measured (e.g., the frequency with which the software component is used in live operation). Frequency may be independent of the number of different transactions in which the software component appears (e.g., a frequently called transaction may cause a unique software component to be invoked more often than a software component that appears in many lesser used transactions). Additionally, some transactions may be viewed more critically than others (e.g., because they involve the accessing and changing of valuable or high security data stores, etc.) and inclusion of a software component in one of these transactions can cause the component's criticality to increase. Criticality values may be determined and can also be reflected in graphical representations of transactions. Graphical representations of overlaps within a system can be used (among other potential visualizations) to assist users in understanding the basis of a given component's criticality.

In some instances, a user can utilize a GUI of a transaction analysis engine, such as those shown and described in FIGS. 6A-6E, to assess a particular portion of the system.

Through graphical identifications of overlaps involving that portion of the system (e.g., as shown in the example of FIG. 6B), a user can better appreciate how a change to any one software component (as displayed within a single transaction's flow) might affect potentially several other transactions (e.g., not (yet) displayed or even known to the user). Additionally, as a change to a component upstream or downstream (e.g., within a transaction flow) from a given component can affect how that component is to operate, identifying overlaps upstream or downstream from a to-be-modified component can also be important considerations and can be visualized using the enhanced GUIs introduced above, among other example advantages. Conversely, determining overlaps within a set of transaction flows can also assist developers and administrators in identifying less critical or used components, prompting the allowance to change, replace, or remove such components, among other examples.

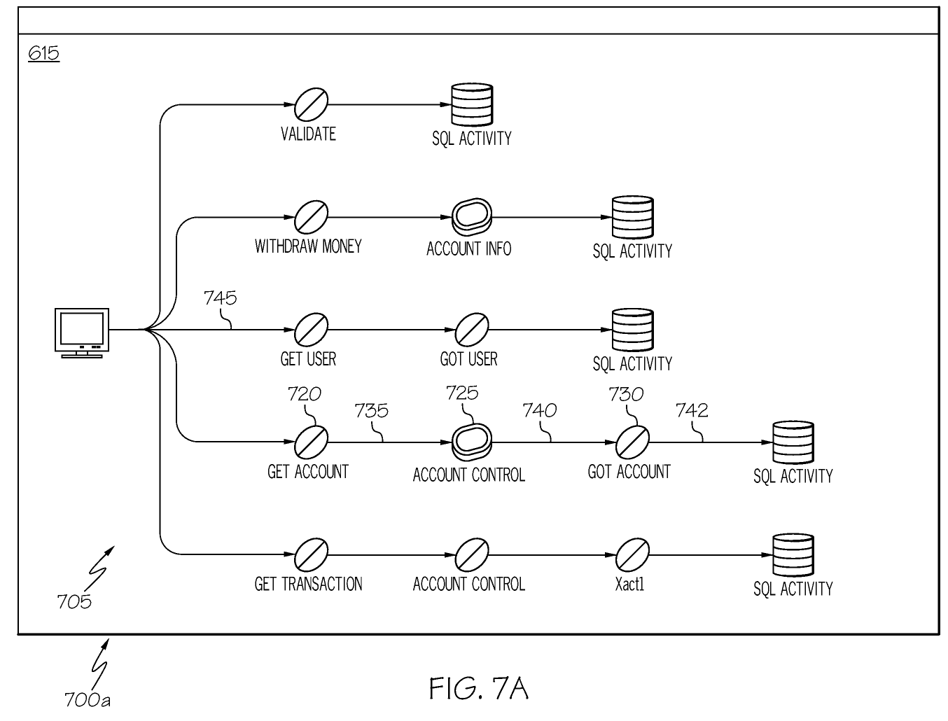

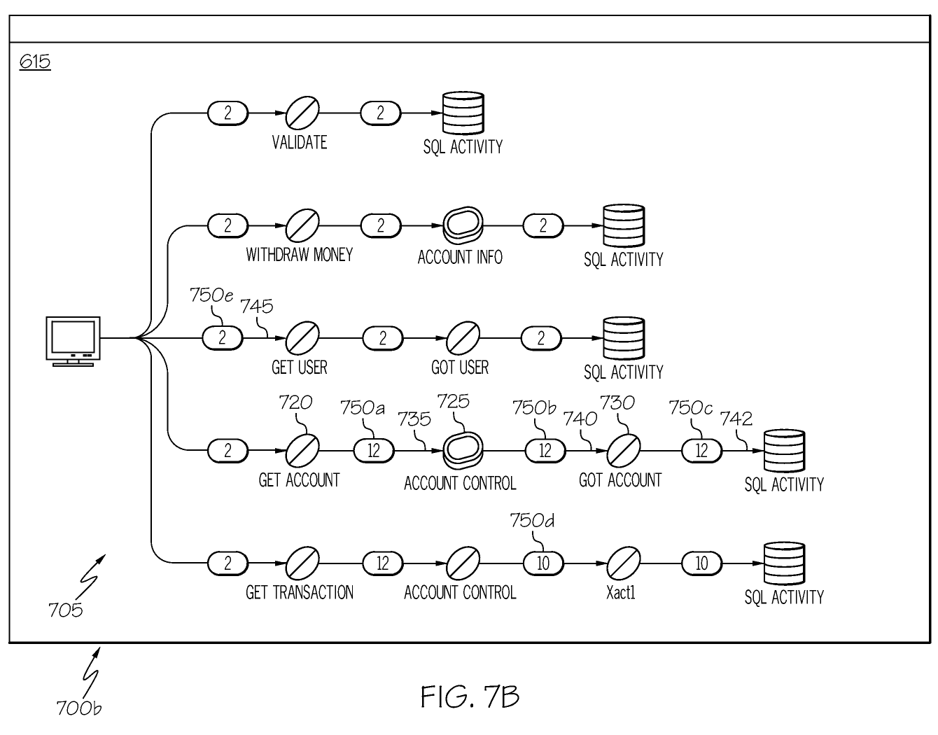

Turning to FIGS. 7A-7B, additional example screenshots 700a-b are shown illustrating additional implementations for visualizing overlaps between transactions in a GUI of a transaction analysis system. For instance, FIG. 7A shows a graphical representation 705 of a set of one or more related transactions. The graphical representation 705, as in other examples, can include a representation of the transaction flow(s) including graphical elements representing participating software components (e.g., 720, 725, 730, etc.) and graphical elements representing corresponding transaction fragments (e.g., 735, 740, 742, 745, etc.). A user can select a control of the GUI to request that any detected transaction overlaps involving the presently displayed (i.e., in 705) transactions be identified. Accordingly, in one implementations, shown in FIG. 7B, graphical overlap identifiers (e.g., 750a-e) can be presented to identify, for each fragment (and in other implementations, for each software components), the number of transactions in which that fragment (or software component) appears. The user can use this information to identify how “deep” an overlap is and how frequently a given transaction fragment and/or software components are used in the various transactions supported by an application, service, or system. For instance, a user can identify that the chain of transaction fragments represented by graphical elements 735, 740, 742 is used in and forms an overlap between at least 12 different transactions. Other transaction fragments and software components may be less used, and a user can identify this through other graphical overlap identifiers (e.g., 750d, 750e) displayed in the GUI window 615. For instance, the transaction fragment corresponding to the graphical element 745 is only used in one other transaction based on the graphical overlap identifier 750e. As in some of the other examples described herein, a user can interact with any one of these graphical elements (e.g., 720, 725, 730, 735, 740, 742, 745, 750a-e) to cause additional information to be displayed and even navigate to other GUI views (e.g., similar to that shown in the example FIG. 6E) that present or assist in illustrating additional aspects of the selected software component, transaction fragment, or overlap, among other examples.

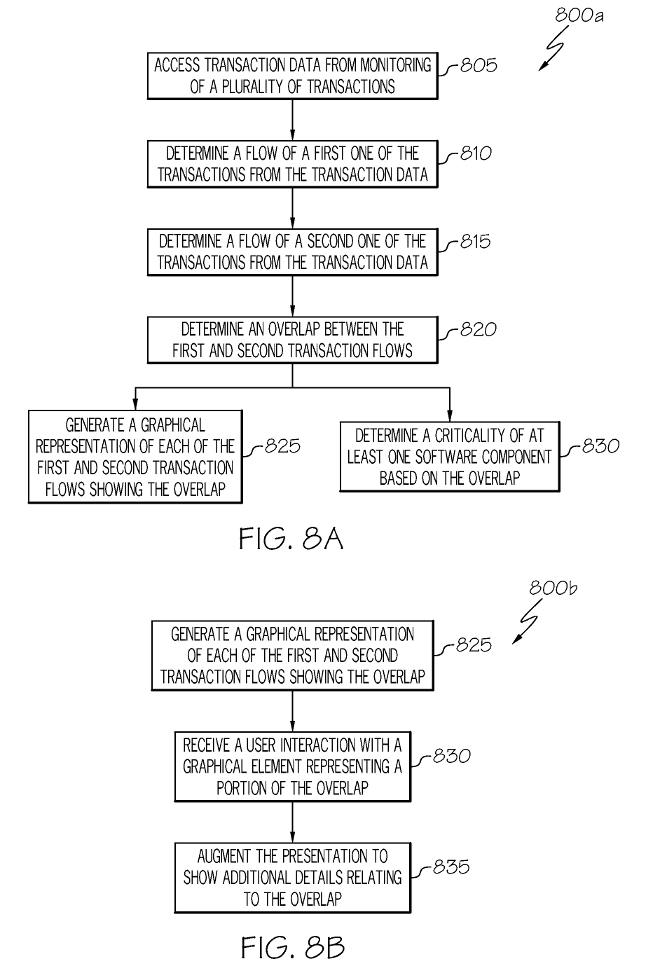

FIGS. 8A-8B are simplified flowcharts 800a-b illustrating an example technique for detecting overlaps between monitored transaction flows. For instance, in the example of FIG. 8A, transaction data can be accessed 805 that has been collected from monitoring of a plurality of transactions. At least some of the transaction data (e.g., the transaction data corresponding to a first transaction) can be accessed from a past monitoring (or “recording”) as stored in computer memory (e.g., with other transaction data from past transaction recordings). Other transaction data can be accessed by running and recording an instance of a transaction and generating corresponding transaction data from the recording. A flow of a first transaction can be determined 810 from at least a portion of the transaction data and a flow of a second transaction can be determined 815 from at least a portion of the transaction data. Determining (810, 815) transaction flow can include generating, or detecting, transaction fragments and stitching the transaction fragments together according to a determined ordering of the fragments. Determining fragments can include determining commonalities between data sent by one component and data (i.e., the same data) received by another component. Stitching can be based on identifying relationships (from the transaction data) between one fragment and another fragment (e.g., such as the receiving of first data by a particular component in a first fragment and the sending of second data (e.g., related to the first data, for instance, by a common values occurring in content in the first and second data) by the particular component in a second fragment), among other techniques. The determined transaction flows can be assessed to identify, or determine 820, overlaps that exist between the different transactions. For instance, each of the first and second transactions can include participation by one or more of the same software components in each. The determined overlap can be used in the generation 835 of a graphical representation of one or both of the first and second transaction flows which highlights the presence of the overlap (e.g., as shown, for instance, in the examples of FIGS. 6B-6E). The determined overlap can also be used in connection with the determination 830, or calculation, of a criticality value for a particular one of the software components. If the software component is determined to be included in one or more detected overlaps, this can raise the criticality of the software component. A criticality value can be used to enforce policies or issue alerts relating to software development, software updates, system security assessment or enforcement, and system risk calculations, among other examples.

Turning to FIG. 8B, in some instances, a graphical representation of the first and second transaction flows can be generated 825 to not only highlight the determined overlap but can be generated as interactive GUIs. Each transaction flow can be generated to include selectable graphical elements corresponding to each of the respective software components and transaction fragments included in the transaction flow. Moreover, selecting any one of these graphical elements can cause the GUI to change is composition or display additional information presenting additional details relating to the selected component. Further, graphical elements used to illustrate the overlap, including graphical elements representing components or fragments included in the overlap, can be interacted with by a user, and these interactions detected 830, to cause the GUI to be augmented 835 to show additional information concerning the overlap. In some cases, a window can be presented to show details concerning the nature of the overlap, including a listing of one or more other transactions overlapping with a transaction whose flow is represented in the GUI display. In other instances, receiving 830 the user interaction can cause additional graphical representations to be presented in the GUI corresponding to the other overlapping transactions. Such presentations can include additional graphical effects to highlight, to a user, how the multiple transaction flows overlap, among other examples.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
accessing transaction data generated during monitoring of a plurality of transactions involving a plurality of software components in a system;
determining, from the transaction data, a flow of a first one of the plurality of transactions, wherein the flow of the first transaction describes participation of a first subset of the plurality of software components in the first transaction;
determining, from the transaction data, a flow of a second one of the plurality of transactions, wherein the flow of the second transaction describes participation of a different, second subset of the plurality of software components in the second transaction; and
determining an overlap between the first and second transactions, wherein the overlap involves a particular one of the software components included in both the first and second subsets of software components.

2. The method of claim 1, further comprising generating a graphical representation of each of the first and second transaction flows.

3. The method of claim 2, wherein each of the graphical representations comprise graphical elements representing each of the software components included in the respective transaction and graphical lines representing the fragments of the respective transaction, wherein each graphical line connects two of the graphical elements to indicate the respective software components participating in the corresponding transaction fragment.

4. The method of claim 3, wherein each graphical representation comprises a respective tree structure illustrating the flow of the corresponding transaction.

5. The method of claim 2, wherein the graphical representations of the first and second transaction flows are presented to illustrate a comparison of the first and second transaction flows.

6. The method of claim 5, further comprising presenting the graphical representations of the first and second transaction flows comparison to highlight the overlap.

7. The method of claim 6, wherein highlighting the overlap comprises enhancing the graphical element representing the particular software component.

8. The method of claim 6, wherein the graphical representations of the first and second transaction flows are presented in a three-dimensional overlay.

9. The method of claim 8, wherein graphical elements of the graphical representations of the first and second transaction flows corresponding to the overlap are aligned in the overlay.

10. The method of claim 8, further comprising determining, from the transaction data, a flow of a third one of the plurality of transactions, wherein the flow of the third transaction describes participation of a different, third subset of the plurality of software components in the third transaction, the overlap comprises an overlap between the first, second, and third transactions, and a graphical representation of the third transaction flow is also presented in the three-dimensional overlay.

11. The method of claim 1, wherein determining the flow of the first transaction comprises:
determining, from the transaction data, a plurality of fragments of the first transaction;
determining relationships between the plurality of fragments; and
stitching the plurality of fragments based on the relationships to define the flow of the first transaction.

12. The method of claim 1, further comprising generating a graphical representation of the first transaction flow, wherein the graphical representation of the first transaction flow indicates the overlap.

13. The method of claim 12, wherein the graphical representation of the first transaction flow of the first transaction flow indicates the overlap by highlighting at least a graphical element, included in the graphical representation, representing the particular software component.

14. The method of claim 13, further comprising:
detecting a user interaction with the graphical element representing the particular software component; and
presenting a graphical representation of the second transaction flow based on the user interaction with the graphical element and the overlap.

15. The method of claim 1, further comprising determining a criticality of the particular software component based on the overlap.

16. The method of claim 1, wherein at least a portion of the transaction data comprises data generated by an agent instrumented on one of the software components and used to monitor fragments of transactions involving the particular software component.

17. A computer program product comprising a computer readable storage medium comprising computer readable program code embodied therewith, the computer readable program code comprising:
computer readable program code configured to access transaction data generated during monitoring of a plurality of transactions involving a plurality of software components in a system;
computer readable program code configured to determine, from the transaction data, a flow of a first one of the plurality of transactions, wherein the flow of the first transaction describes participation of a first subset of the plurality of software components in the first transaction;
computer readable program code configured to determine, from the transaction data, a flow of a second one of the plurality of transactions, wherein the flow of the second transaction describes participation of a different, second subset of the plurality of software components in the second transaction;
computer readable program code configured to determine an overlap between the first and second transactions, wherein the overlap involves a particular one of the software components included in both the first and second subsets of software components; and
computer readable program code configured to generate a graphical representation of each of the first and second transaction flows and highlight the overlap between the first and second transactions.

18. A system comprising:
a data processing apparatus;
a memory device;
a software transaction monitor to:
access transaction data generated during monitoring of a plurality of transactions involving a plurality of software components in a system;
determine, from the transaction data, a flow of a first one of the plurality of transactions, wherein the flow of the first transaction describes participation of a first subset of the plurality of software components in the first transaction;
determine, from the transaction data, a flow of a second one of the plurality of transactions, wherein the flow of the second transaction describes participation of a different, second subset of the plurality of software components in the second transaction; and
determine an overlap between the first and second transactions, wherein the overlap involves a particular one of the software components included in both the first and second subsets of software components

19. The system of claim 18, further comprising a graphical user interface (GUI) engine to generate a GUI to comprise a graphical representation of each of the first and second transaction flows, wherein the graphical representations are presented to highlight the overlap between the first and second transactions.

20. The system of claim 18, further comprising a criticality engine to determine a criticality value for the particular software component based at least in part on the overlap.
